(19) United States
(12) Patent Application Publication
(10) Pub. No.: US 2024/0424750 A1
(43) Pub. Date: Dec. 26, 2024

(54) TECHNIQUES FOR FABRICATING COMPOSITE REBARS AND BEAMS

(71) Applicant: Xaba Inc., Toronto (CA)

(72) Inventors: Massimiliano MORUZZI, Rockford, IL (US); Francesco IORIO, Toronto (CA)

(21) Appl. No.: 18/752,646

(22) Filed: Jun. 24, 2024

Related U.S. Application Data
(60) Provisional application No. 63/510,332, filed on Jun. 26, 2023.

(51) Int. Cl. B29C 70/52; B29C 70/54

(52) U.S. Cl. CPC B29C 70/523; B29C 70/527; B29C 70/545

(57) ABSTRACT

An apparatus for fabricating a composite structural member includes: a polymer mold with a mold cavity and an inlet, wherein the inlet is fluidly coupled to the mold cavity and receives a fluid that includes a polymer; a fiber inlet that is disposed on a first end of the mold cavity and includes a fiber-positioning plate; and a tensioner that exerts a tensile force on one or more fiber strands that are routed through the fiber positioning plate.

### CROSS-REFERENCE TO RELATED APPLICATIONS

This application claims priority benefit of the United States Provisional patent application titled, “TECHNIQUES FOR FABRICATING COMPOSITE REBARS AND BEAMS” filed on Jun. 26, 2023, and having Ser. No. 63/510,332. The subject matter of this related application is hereby incorporated herein by reference.

### BACKGROUND

### Field of the Various Embodiments

The various embodiments relate generally to mechanics of materials and related fabrication techniques and, more specifically, to fabricating composite rebars and beams.

### Description of the Related Art

Concrete spalling caused by steel reinforcement corrosion is a significant issue that often leads to structural deterioration and the premature end of service life of structures. In the US alone, corrosion of both steel and reinforced concrete infrastructure costs the economy an estimated US$22 billion each year. Furthermore, the steel industry is one of the largest producers of carbon dioxide in the world. By some estimates, over 20% of all steel produced is used for concrete reinforcement, the production of which equates to 1.5% of global carbon dioxide emissions.

In view of the foregoing, glass fiber reinforced polymer (GFRP) has been developed as a more environmentally-friendly alternative to steel for concrete reinforcement. The production of GFRP reinforcement bars (“rebar”) requires less than half the carbon dioxide emissions required for producing equivalent steel rebar. In addition, GFRP rebar is one quarter the weight of steel, making transport more efficient by substantially increasing the volume of rebar that can be carried by a single truck. Accordingly, the use of GFRP rebar can significantly reduce freight costs and emissions associated with the transport of construction materials. Further, GFRP rebar prevents reinforced concrete structures from deteriorating long before the designed lifespan. Oftentimes, poor quality control during construction and/or construction in harsh environments can lead to premature corrosion of steel rebar. For example, premature corrosion of steel rebar in a concrete structure with a nominal service life of 50 years can reduce the useful life of the structure to as little as 10-20 years. GFRP rebar, which is not subject to corrosion, is a viable alternative to steel rebar given that GFRP rebar eliminates one of the biggest vulnerabilities of reinforced concrete—corrosion-induced concrete spalling.

One drawback of using GFRP rebar is that the conventional process employed to produce GFRP rebar inefficiently uses reinforcing fibers. In this regard, GFRP rebar is typically formed by pultrusion of a bundle of resin-impregnated glass fibers through a die that cures and shapes the rebar as the resin polymerizes. Such an approach results in the reinforcing fiber accounting for the majority of the mass of the rebar, which greatly increases the cost of the rebar. Another drawback of using GFRP rebar is that the fiber bundle and the polymerized resin may not simultaneously contribute to the mechanical performance of the rebar. In this regard, most or all of the fibers of a given bundle typically are not straight and parallel with the axis of the rebar. Instead, the fibers of a given bundle usually follow curved paths that are only roughly parallel to the axis of the rebar. Such fibers deflect and straighten out under a tensile load and, therefore, primarily contribute to the axial rigidity of the rebar only after a reasonable amount axial deflection of the rebar has occurred. Consequently, the large number of reinforcing fibers in a conventional GFRP rebar confer only some axial rigidity to the rebar, which means that the axial strength of the reinforcing fibers in GFRB rebar is typically used inefficiently.

As the foregoing illustrates, what is needed in the art are more effective techniques for fabricating reinforcement bars.

### SUMMARY

An apparatus for fabricating a composite structural member, the apparatus comprising: a polymer mold with a mold cavity and an inlet, wherein the inlet is fluidly coupled to the mold cavity and receives a fluid that includes a polymer; a fiber inlet that is disposed on a first end of the mold cavity and includes a fiber-positioning plate; and a tensioner that exerts a tensile force on one or more fiber strands that are routed through the fiber positioning plate.

At least one technical advantage of the disclosed techniques relative to the prior art is that the disclosed techniques enable fiber-reinforced composite rebars and beams that have mechanical properties equivalent to conventional composite rebars and beams that include many more reinforcing fibers to be fabricated. A further advantage is that the disclosed techniques enable fiber-reinforced composite rebars and beams that include pre-tensioned reinforcing fibers that enhance the mechanical properties of those rebar and beams to be fabricated. These technical advantages provide one or more technological advancements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments. 1

FIG. 1 conceptually illustrates a cross section of a composite structural member, according to various embodiments.

FIG. 2 conceptually illustrates a side cross section of the composite structural member of FIG. 1, according to various embodiments

FIG. 3 conceptually illustrates a fabrication system configured to implement one or more aspects of the various embodiments.

FIG. 4 is a more detailed illustration of the polymer mold of FIG. 3, according to various embodiments.

FIG. 5A is a plan view of the fiber-positioning plate of FIG. 4, according to various embodiments.

FIG. 5B is a side view of the fiber-positioning plate of FIG. 4, according to various embodiments.

FIG. 6 is a more detailed illustration of the polymer mold of FIG. 3, according to various other embodiments.

FIG. 7 sets forth a flowchart of method steps for fabricating a composite structural member using an extrusion process, according to various embodiments.

FIGS. 8A-8D conceptually illustrate various steps included in the method of FIG. 7, according to various embodiments.

FIG. 9 sets forth a flowchart of method steps for fabricating a composite structural member using an extrusion process, according to other various embodiments.

FIGS. 10A-10D conceptually illustrate various steps included in the method of FIG. 9, according to other various embodiments

For clarity, identical reference numbers have been used, where applicable, to designate identical elements that are common between figures. It is contemplated that features of one embodiment may be incorporated in other embodiments without further recitation.

### DETAILED DESCRIPTION

In the following description, numerous specific details are set forth to provide a more thorough understanding of the various embodiments. However, it will be apparent to one of skill in the art that the inventive concepts may be practiced without one or more of these specific details.

### Fiber-Reinforced Composite Structural Member

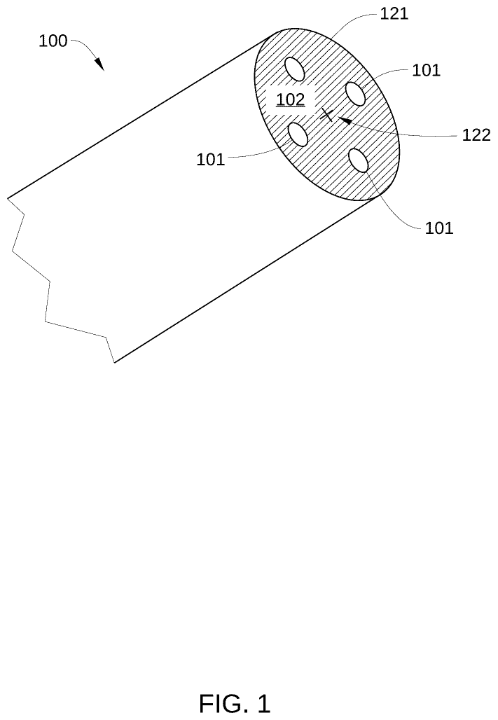

FIG. 1 conceptually illustrates a cross section of a composite structural member 100, according to various embodiments. In some embodiments, composite structural member 100 is a fiber-reinforced polymeric member, such as a reinforcing bar (commonly referred to as “rebar”) that can be employed to structurally reinforce a concrete structure. Thus, in the embodiment illustrated in FIG. 1, composite structural member 100 has a circular cross-section. In other embodiments, composite structural member 100 can have any technically feasible cross section that can be achieved via the methods and techniques describe herein, such as an oval, rectangular, or square cross-section. In some embodiments, composite structural member 100 can have a more complex cross section, such as a ring, hollow rectangle, T-beam, I-beam, L-beam, or U-channel, or any other cross-section that can provide bending and/or axial rigidity to a concrete structure when incorporated therein. As shown, composite structural member 100 includes one or more fiber strands 101 that are positioned within a cured polymer 102 (cross-hatched) of composite structural member 100.

Fiber strands 101 can include one or more glass fibers, carbon fibers, recycled fibers (such as polymer-based fibers), aramid fibers, natural fibers, and/or the like. Further, in some embodiments, each fiber strand 101 is a single fiber, and in other embodiments, each fiber strand 101 is a group of braided or twisted fibers. In some embodiments, the type of fiber material included in fiber strands 101 is selected based on one or more materials included in cured polymer 102.

Cured polymer 102 can be any polymer suitable for use in a reinforcement bar or other structural member. For example, in some embodiments, cured polymer includes at least one of a thermoplastic polymer, a thermo-setting resin, or a polyamide-containing material. The polymer or polymers included in cured polymer 102 can be selected based on specific requirements of the application for composite structural member 100, including mechanical performance and durability in various environmental conditions.

Generally, the diameter, material, and position of fiber strands 101 can be selected based on a particular application for fiber-reinforced plastic member 100. For example, in some embodiments, fiber strands 101 are selected to provide additional axial rigidity and increased tensile strength to composite structural member 100. In such embodiments, one or more fiber strands 101 are positioned within cured polymer 102 (cross-hatched) of composite structural member 100, and are reinforcing fibers that provide additional axial rigidity and increased tensile strength to composite structural member 100. In the embodiment shown in FIG. 1, composite structural member 100 includes four fiber strands 101 that are positioned between an outer surface 121 of composite structural member 100 and a center axis 122 of composite structural member 100. In other embodiments, any other technically feasible number of fiber strands 101 can be positioned within cured polymer 102. For example, in such embodiments, composite structural member 100 includes more than or fewer than four fiber strands 101 positioned between outer surface 121 and center axis 122 of composite structural member 100. In some embodiments, each fiber strand 101 is separated from each other fiber strand 101. Thus, in such embodiments, each fiber strand 101 does not contact another fiber strand 101 included in composite structural member 100.

In some embodiments, fiber strands 101 are positioned to enable bending of composite structural member 100 into a specified shape during fabrication. In such embodiments, fiber strands 101 may have a composition and be positioned within cured polymer 102 to provide flexibility to composite structural member 100 during the bending process. For example, in such embodiments, fiber strands 101 may include an elastic fiber, such as hemp, that enables bending of a segment of composite structural member 100 during fabrication. Alternatively or additionally, in such embodiments, fiber strands 101 may be interwoven, layered, or otherwise positioned within cured polymer 102 to allow for movement and bending of composite structural member 100 during a bending process without compromising the structural integrity of composite structural member 100. Alternatively or additionally, in such embodiments, fiber strands 101 may include a surface treatment that enables each fiber in fiber strands 101 to elongate, such as the formation of micro-disruptions or micro-cuts on the surface of each fiber. In such embodiments, the ability of the fibers within fiber strands 101 to elongate enables the bending of composite structural member 100 during a bending process described below.

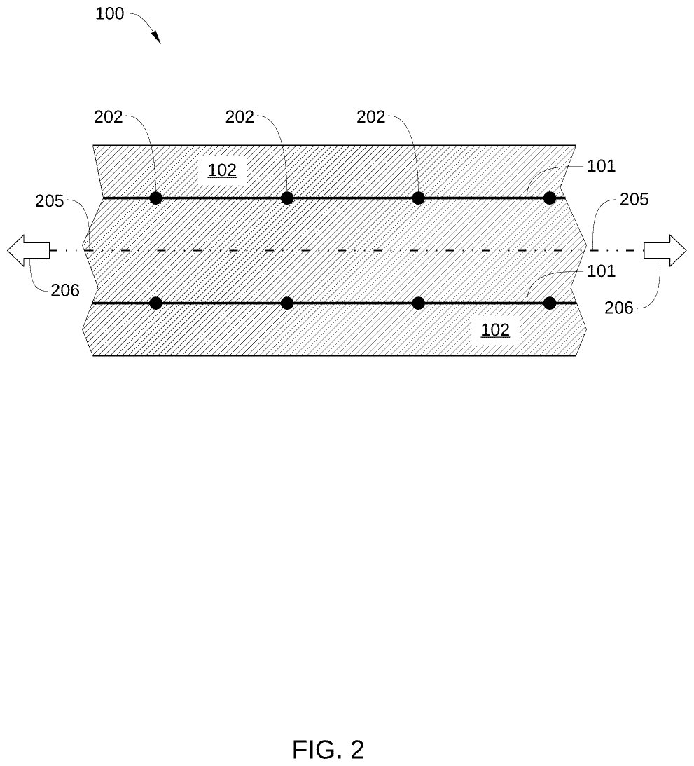

According to various embodiments, fiber strands 101 are pre-tensioned when composite structural member 100 is formed, for example via the exertion of a tensile force on fiber strands 101 during fabrication of composite structural member 100. As a result, fiber strands 101 are generally straight and parallel with the longitudinal axis of composite structural member 100, which enhances the mechanical performance of composite structural member 100. Specifically, fiber strands 101 can contribute to the axial rigidity of composite structural member 100 before axial deflection of the rebar has occurred, since fiber strands 101 do not follow curved paths within composite structural member 100. Further, in some embodiments fiber strands 101 have a plurality of knots formed therein. In such embodiments, the knots act a uniform distribution of anchoring points between fiber strands 101 and cured polymer 102, thereby producing homogeneous structure behavior in composite structural member 100. One such embodiment is described below in conjunction with FIG. 2.

FIG. 2 conceptually illustrates a side cross section of composite structural member 100, according to various embodiments. As shown, composite structural member 100 includes multiple pre-tensioned fiber strands 101 that are enclosed within cured polymer 102. Pre-tensioned fiber strands 101 are formed with a tensile force (not shown) exerted thereon during fabrication of composite structural member 100. Therefore, pre-tensioned fiber strands 101 are straight and parallel with a longitudinal axis 205 of composite structural member 100. Pre-tensioned fiber strands 101 also include a plurality of knots 202 formed therein. Because pre-tensioned fiber strands 101 are parallel with longitudinal axis 205 and do not follow curved paths within composite structural member 100, an axial load 206 parallel with longitudinal axis 205 that is applied to composite structural member 100 encounters the weakest mechanical interaction between pre-tensioned fiber strands 101 and cured polymer 102. Consequently, fiber strands may not respond to axial load 206 simultaneously with cured polymer 102. However, knots 202 act as additional anchoring points between pre-tensioned fiber strands 101 and cured polymer 102, thereby increasing the mechanical interaction or bond between pre-tensioned fiber strands 101 and cured polymer 102. As a result, pre-tensioned fiber strands 101 and cured polymer 102 respond to a load applied to composite structural member 100 simultaneously, since knots 202 mechanically couple pre-tensioned fiber strands 101 and cured polymer 102. In some embodiments, knots 202 are equally spaced along fiber strands 101 as shown. In other embodiments, knots 202 are not equally space and are instead disposed at certain locations along fiber strands 101 to provide enhanced mechanical coupling at specified locations within composite structural member 100.

### System Overview

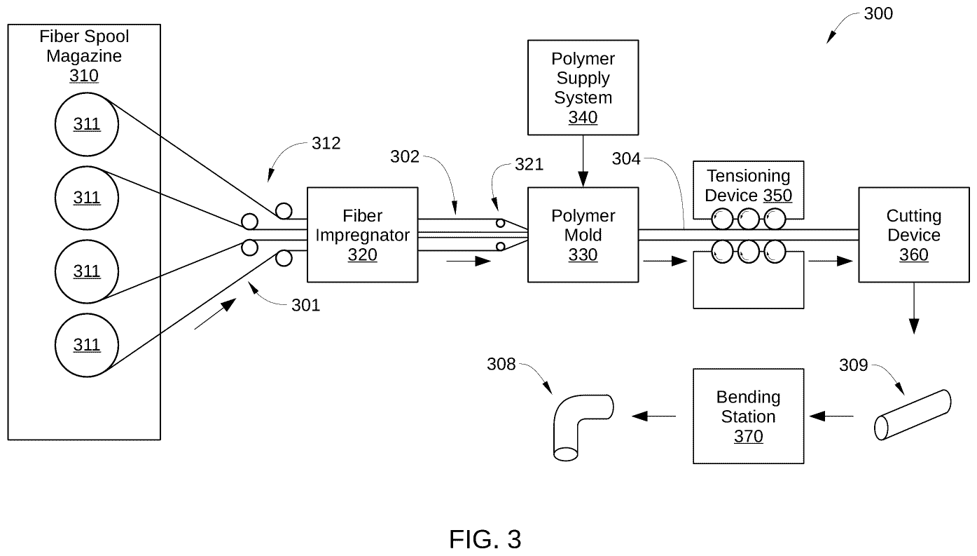

FIG. 3 conceptually illustrates a fabrication system 300 configured to implement one or more aspects of the various embodiments. Fabrication system 300 enables fabrication of fiber-reinforced composite rebars and beams that have the mechanical properties of conventional composite rebars and beams having orders of magnitude more reinforcing fibers. In some embodiments, the fiber-reinforced composite rebars and beams include pre-tensioned and precisely positioned reinforcing fibers disposed within a cured polymer that enhance the mechanical properties of the rebars and beams. In the embodiment illustrated in FIG. 3, fabrication system 300 includes a fiber spool magazine 310, a fiber impregnator 120, a polymer mold 130, a polymer supply system 140, a tensioning device 150, a cutting device 160, and a bending station 170.

Fiber spool magazine 310 includes a plurality of fiber spools 311 that each supply a respective fiber strand 301 for inclusion in the composite structural members 309 that are produced by fabrication system 300. In some embodiments, fiber strands 301 are consistent with fiber strands 101 of FIG. 1 and FIG. 2. In some embodiments, fiber strands 301 are conveyed or routed to fiber impregnator 320 via rollers 311, guides, and/or the like.

Fiber impregnator 320 saturates, wets, or otherwise impregnates fiber strands 301 prior to the molding and curing of polymer-containing fluid 303 with a suitable resin or other impregnation liquid. Fiber impregnation is performed by fiber impregnator 320 to enhance or enable bonding between fiber strands 301 and a polymer-containing fluid 303 employed to form the cured polymer bulk material of composite structural members 309. In some embodiments, fiber impregnation involves pulling fiber strands 301 through a bath of a suitable resin or impregnation liquid or by spraying a suitable resin or impregnation liquid onto fiber strands 301. In some embodiments, fiber strands 301 are conveyed or routed to fiber impregnator 320 via rollers 311, guides, and/or the like.

The material or materials employed to impregnate fiber strands 301 can be selected depending on the type of fiber included in fiber strands 301 and/or the type of polymer in polymer-containing fluid 303. Examples of such impregnation liquids or resins include polyester, polyurethane, vinyl ester, and epoxy resins. Different fibers (such as glass, carbon, or aramid fibers) have varying affinities and compatibility with different resins. Therefore, to ensure proper bonding and structural integrity, the type of fiber in fiber strands 301 can determine the resin or impregnation liquid used to impregnate fiber strands 301. For example, glass fibers typically require resins that can penetrate and adhere well to the surface of such fibers, such as epoxy, polyester or vinyl ester. In embodiments in which fiber strands 301 include carbon fibers, which are more chemically inert than glass fibers, to achieve optimal bonding, fiber strands 301 can be impregnated with specialized epoxy resins. Furthermore, because the bulk portion of composite structural members 309 is formed from a specific polymer, in some embodiments, the impregnation liquid is selected to be compatible with that specific polymer to ensure a cohesive structure of composite structural members 309. Alternatively or additionally, in some embodiments, a wetting agent can be included in the resin or impregnation liquid used to impregnate fiber strands 301. For example, in embodiments in which the bulk portion of composite structural members 309 is formed from a thermoplastic polymer, the impregnation liquid is selected to chemically and/or mechanically bond well with that thermoplastic polymer. Additionally, to ensure proper bonding and structural integrity, the type of fiber in fiber strands 301 can determine the resin or impregnation liquid used to impregnate fiber strands 301.

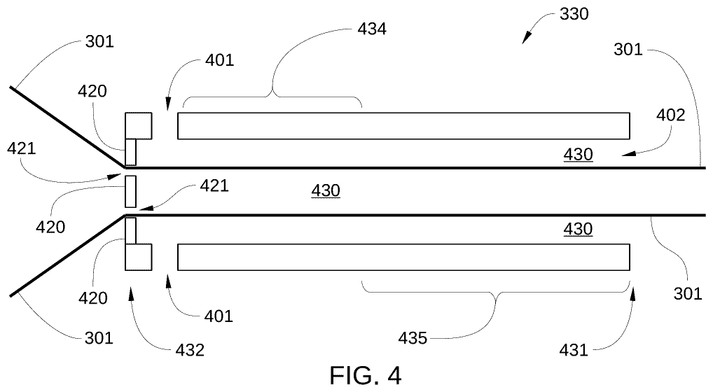

Polymer mold 330 is a chamber of fabrication system 300, such as a forming die, configured to form the bulk portion of composite structural members 309 by curing polymer-containing fluid 303 disposed within polymer mold 330. In addition, polymer mold 330 cures the polymer-containing fluid 303 disposed within polymer mold 330 while a tensile force (not shown) is exerted on each fiber strand 301 disposed within polymer mold 330, for example via tensioning device 150. Further, polymer mold 330 cures the polymer-containing fluid 303 disposed within polymer mold 330 while each fiber strand 301 disposed within polymer mold 330 is positioned at a respective location. One embodiment of polymer mold 330 is described below in conjunction with FIG. 4.

FIG. 4 is a more detailed illustration of polymer mold 330, according to various embodiments. In the embodiment illustrated in FIG. 4, polymer mold 330 includes a mold cavity 430, one or more inlets 401 for entry of polymer-containing fluid, a mold outlet 402 located at a first end 431 of mold cavity 430, and a fiber-positioning plate 420 disposed on a second end 432 of mold cavity 430. Also shown in FIG. 4 are multiple fiber strands 301 positioned at different respective locations within mold cavity 430. Polymer mold 330 receives a polymer-containing fluid, such as polymer-containing fluid 303 in FIG. 3 via inlets 401 and cures the polymer-containing fluid to form a segment of a composite structural member 309 shown in FIG. 3.

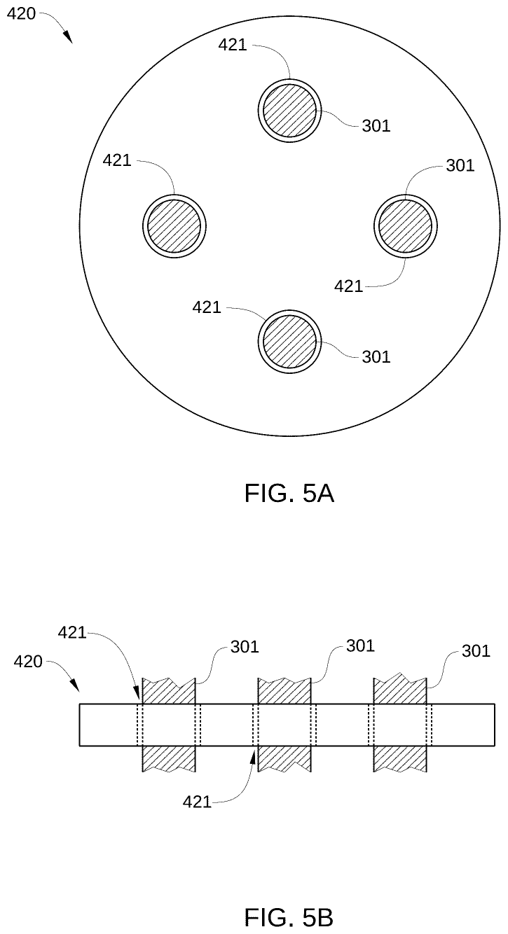

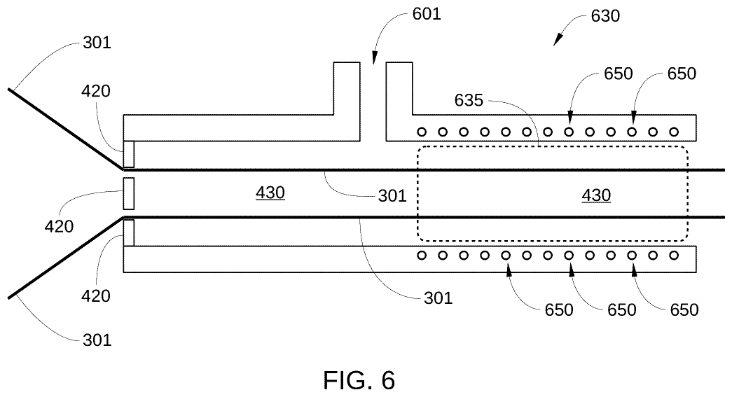

In FIG. 4, inlets 401 are located proximate first end 431 of mold cavity 430, which is the opposite end of mold cavity 430 from second end 432. In other embodiments, one or more inlets 401 are located at different locations along the length of mold cavity 430 and/or at first end 431 of mold cavity 430, for example between fiber-locating openings 421 of fiber-positioning plate 420. Fiber-positioning plate 420 includes one fiber-locating opening for each of the one or more fiber strands 301 positioned within mold cavity 430. In operation, one fiber strand 301 is routed through each fiber-locating opening 421 during fabrication of the composite structural members 309 in FIG. 3. As shown, each fiber-locating opening 421 of fiber-positioning plate 420 positions one fiber strand 301 at a different respective location within mold cavity 430. In some embodiments, each different respective location is located between an inner surface 432 of mold cavity 430 and a center axis 405 of mold cavity 430. One embodiment of fiber-positioning plate 420 is described below in conjunction with FIGS. 5A and 5B.

FIG. 5A is a plan view of fiber-positioning plate 420 and FIG. 5B is a side view of fiber-positioning plate 420, according to various embodiments. In the embodiment shown in FIGS. 5A and 5B, fiber-positioning plate 420 includes four fiber-locating openings 421 for positioning fiber strands 301 (cross-hatched) within a mold cavity, such as mold cavity 430 in FIG. 4. In other embodiments, fiber-positioning plate 420 can include any suitable number of appropriately positioned fiber-locating openings 421.

Returning to FIG. 4, in some embodiments, polymer mold 330 is implemented as a cooling mold that forms composite structural members 309 via an extrusion process. For example, in such embodiments, the polymer-containing fluid received by mold cavity 430 includes a thermoplastic and/or polyamide, both of which are cured by cooling. Thus, in such embodiments, the polymer-containing fluid received by mold cavity 430 cools within a cooling region 435 of polymer mold 330. For example, in such embodiments, the polymer-containing fluid received by mold cavity 430 is cooled to a temperature below a solidification temperature of the polymer-containing fluid. In embodiments in which polymer mold 330 forms composite structural members 309 via an extrusion process, mold cavity 430 receives the polymer-containing fluid received in a casting region 434 and cools the polymer-containing fluid in a cooling region 435. After sufficient cooling, a solidified segment of a composite structure member 309 exits polymer mold 330 via mold outlet 402. Typically, in the extrusion process, the solidified segment of a composite structure member 309 continuously exits mold outlet 402, for example at a fixed velocity.

In other embodiments, polymer mold 330 is implemented as a thermal curing mold that forms composite structural members 309 via an injection process. For example, in such embodiments, the polymer-containing fluid received by mold cavity 430 includes a thermo-setting polymer that is cured by heating. Thus, in such embodiments, the polymer-containing fluid received by mold cavity 430 is heated within a thermal curing region of polymer mold 330. One such embodiment is described below in conjunction with FIG. 6.

FIG. 6 is a more detailed illustration of polymer mold 630, according to various embodiments. In the embodiment illustrated in FIG. 6, polymer mold 630 can be consistent with polymer mold 330 of FIGS. 3 and 4, except that polymer mold 630 includes a thermal curing region 635 and associated thermal curing devices 650 in lieu of a cooling region 435. In polymer mold 630, thermal curing devices 650 are heat-generating devices for thermally curing the polymer-containing fluid disposed within thermal curing region 635. Thermal curing devices 650 can include any devices capable of thermally curing the polymer-containing fluid disposed within thermal curing region 635, such as an electrical heat source, a microwave heat source, a source of ultra-violet rays, and/or a source of infra-red rays.

In operation, polymer mold 630 receives a polymer-containing fluid via inlet 601 and thermally cures the polymer-containing fluid to form a segment of a composite structural member 309 shown in FIG. 3. For example, in some embodiments, the polymer-containing fluid received by mold cavity 430 is heated to a temperature equal to or greater than a curing temperature of the polymer-containing fluid. In injection process, mold cavity 430 receives the polymer-containing fluid received in a casting region 634 and cures the polymer-containing fluid in thermal curing region 635. After sufficient curing, a solidified segment of a composite structure member 309 exits polymer mold 330 via mold outlet 402. Typically, in the injection process, upon completion of thermal curing, a discrete segment of a composite structure member 309 is advanced from polymer mold 630.

Returning to FIG. 3, polymer supply system 340 provides polymer-containing liquid 303 to an inlet of polymer mold 330. Polymer-containing fluid 303 can be a liquid. Alternatively, for certain resins or polymer-containing materials that do not have a distinct melting point, polymer-containing fluid 303 can be a waxy or semi-solid fluid or other non-solid fluid. Generally, polymer supply system 340 can vary in configuration depending on the type of polymer included in polymer-containing fluid 303 as well as the specific requirements of fabrication process for composite structure member 309. In some embodiments, polymer supply system 340 is implemented as a hopper/auger system that includes a hopper to hold polymer pellets that are then fed into a melting device or chamber via an auger. Such embodiments are suitable for thermoplastic polymers that are supplied in pellet form. In such embodiments, for certain applications preheated polymer pellets can be directly fed into an extruder or polymer mold 330 to reduce energy consumption during melting. Alternatively, in some embodiments, polymer supply system 340 is implemented as a liquid distribution system for thermo-setting resins or liquid polymers. In such embodiments, the liquid distribution system can include pump systems for pumping liquid polymers or resins to the polymer mold, metering systems for precision control of the flow rate of polymer-containing fluid 303, and mixing systems. For example, in embodiments in which polymer-containing fluid 303 includes two-part thermo-setting resins, a mixing system can combine the two components in the correct ratio before delivering the mixture to polymer mold 330. Thus, in such embodiments, polymer supply system 340 includes a mixing system that combines a first part of a thermo-setting resin included in the polymer-containing liquid with a second part of the thermo-setting resin included in the polymer-containing liquid before the polymer-containing liquid enters polymer mold 330. Alternatively, in some embodiments, polymer supply system 340 is implemented as a granule feeding system that uses granules of polymers instead of pellets. In such embodiments, the granule feeding system can have feeding mechanisms to a pellet-handling system, such as a hopper and/or vibratory feeders to ensure continuous supply.

Tensioning device 350 facilitates properly alignment and tension of fiber strands 301 during the process of fabricating composite structural members 309. In some embodiments, tensioning device 350 includes pulling rollers that grip a segment of composite structural member 309 that has exited polymer mold 330, thereby maintaining tension on the segments of fiber strands 301 disposed within polymer cavity 330. In some embodiments, tensioning device 350 includes tensioning clamps, such as mechanical or pneumatic clamps can hold and tension in fiber strands 301. In such embodiments, these clamps can adjust tension dynamically to ensure consistent alignment of fiber strands 301 with polymer cavity 330. In some embodiments, tensioning device 350 includes a servo-driven system that can provide precise control of fiber tension. Such systems can adjust tension based on real-time feedback to maintain optimal conditions. In some embodiments, tensioning device 350 includes weight-based tensioning that can apply constant tension to fiber strands 301. In some embodiments, tensioning device 350 includes hydraulic tensioning system, which can provide adjustable and consistent tensioning of fiber strands 301.

Cutting device 360 cuts a continuous composite structural member 304 that is produced by polymer mold 330 into composite structural members 309. Generally, cutting device 360 is selected to be capable of cleanly cutting the rebar to the desired length without damaging the fibers or the polymer matrix. Thus, in some embodiments, cutting device 360 can be selected based on various factors, such as the type of polymer included in composite structural members 309, the type of fibers included in composite structural members 309, the required precision of the cut, and the production speed. In some embodiments, cutting device 360 includes mechanical shear cutters, which can be used for most thermoplastic structural members. These cutters apply a shearing force to cut through the material. In some embodiments, cutting device 360 includes saw blades, such as circular saw blades or band saws, which can be used for cutting thicker or more rigid structural members. The blade material and tooth design for such saw blades generally depends on the type of polymer and fibers included in composite structural member 304. In some embodiments, cutting device 360 includes laser cutters for precise cutting, especially for intricate shapes and/or high-strength fibers. In some embodiments, cutting device 360 includes hot knife cutters for thermoplastic polymers. Hot knife cutters can melt through such material, providing a clean cut without fraying the fiber strands 301 disposed within composite structural member 304. In some embodiments, cutting device 360 includes water jet cutters, which employ high-pressure water jets to cut through various types of structural members without generating heat, thereby preventing thermal degradation. In some embodiments, cutting device 360 includes rotary cutting devices with replaceable blades, which can provide clean and consistent cuts. Rotary cutting devices can facilitate the fabrication of composite structural members 309 in continuous production lines.

Bending station 370 heats, bends, and cools composite structural members 309 t. In embodiments in which composite structural members 309 include polyamide, composite structural members 309 can be bent to a non-linear shape, such as an L configuration, a U configuration, and the like. Polyamide is a polymer that has high flexibility and tensile strength, and therefore is well-suited for applications requiring bendability. In some embodiments, bending station 370 is configured to heat a particular portion of a composite structural member 309 to a temperature at or above a softening point of polyamide, facilitate or cause the bending of the composite structural member 309 at the heated portion, and cool the resulting non-linear composite structural member 308 until no longer bendable. In such embodiments, bending station 370 can include jigs or other manual tools and/or an automated bending system.

### Extrusion Process

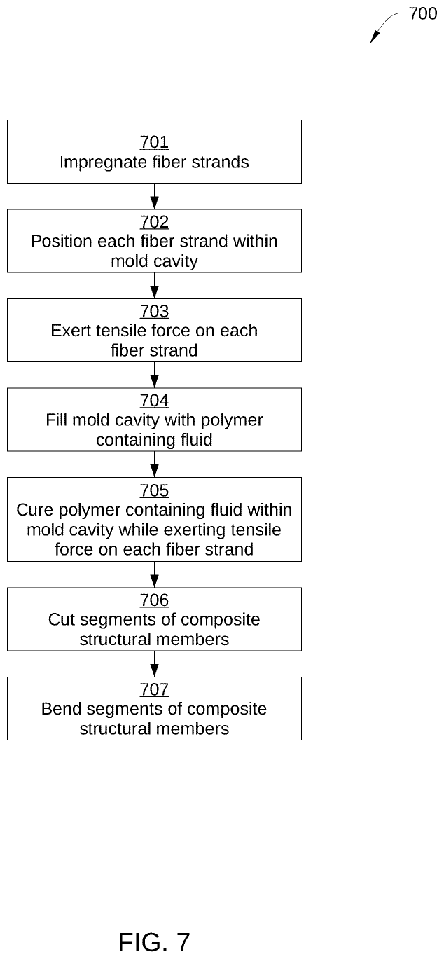

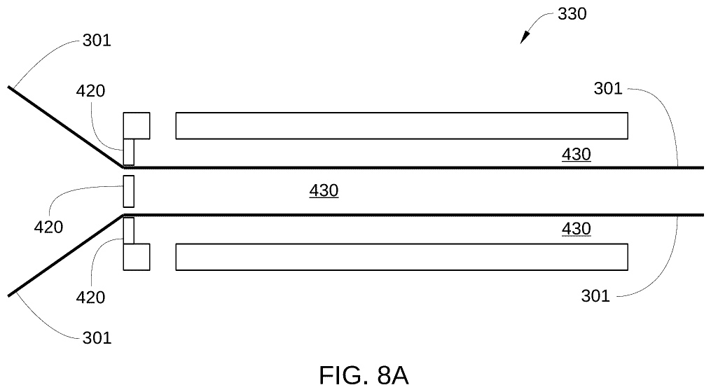

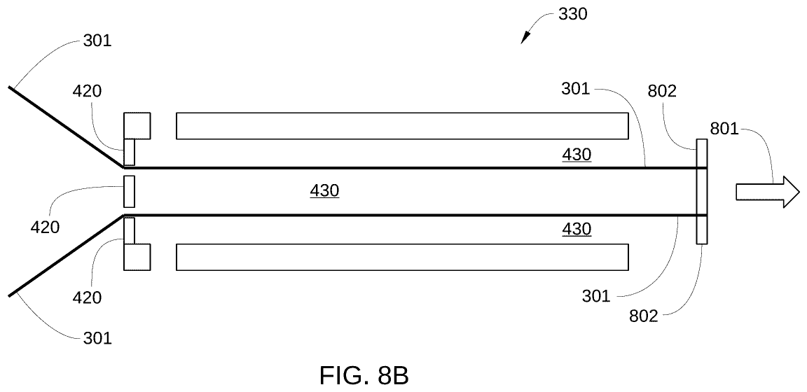

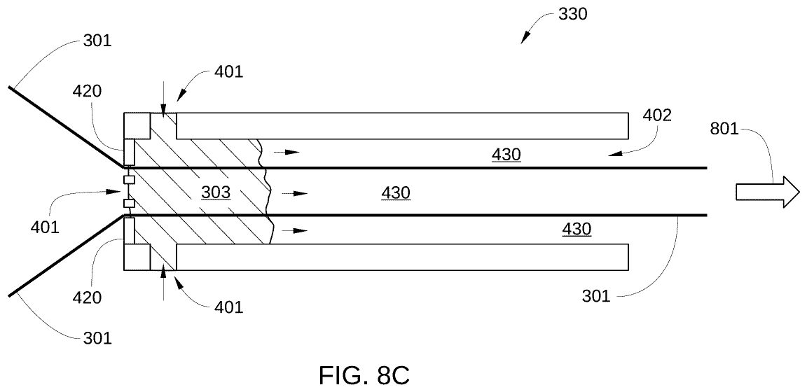

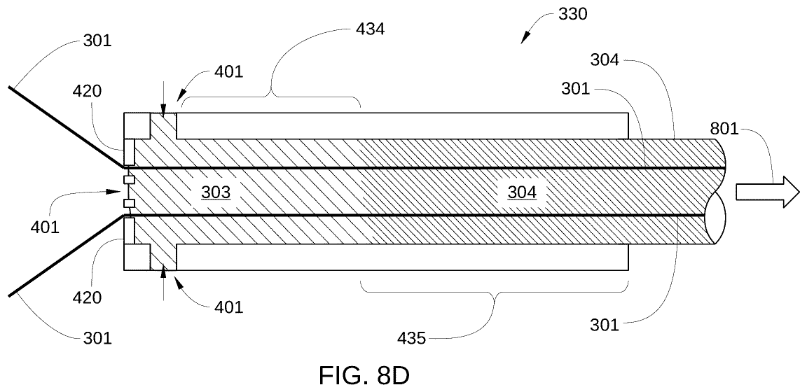

In some embodiments, a novel extrusion process is employed to fabricate a composite rebar, beam, or other structural member. In a conventional pultrusion process, a fiber-reinforced composite member with a constant cross-section can be continuously formed by the pulling of a plurality of resin-impregnated reinforcing fibers (or braided strands) through a heated die. Thus, the cross-section of the fiber-reinforced composite member is determined by the die opening. As a result, the reinforcing fibers, which are typically compressed together via the die opening, are bundled together within the fiber-reinforced composite member and are not discretely positioned within the composite member. By contrast, in the novel extrusion process, individual fibers (or braided strands) are positioned at specific locations within a mold cavity while under tension. A polymer-containing fluid is then injected into the mold and cured via cooling to form a segment of a fiber-reinforced composite member. As the resin is cured, a composite structural member is extruded continuously from the mold cavity, for example at a velocity selected to facilitate curing of the fiber-reinforced composite member. One embodiment of such an extrusion method is described below in conjunction with FIGS. 7 and 8A-8D.

FIG. 7 sets forth a flowchart of method steps for fabricating a composite structural member using an extrusion process, according to various embodiments. FIGS. 8A-8D conceptually illustrate various steps included in the method of FIG. 7, according to various embodiments. Although the method steps are described in conjunction with the systems of FIGS. 1-6, persons skilled in the art will understand that any system configured to perform the method steps, in any order, is within the scope of the embodiments.

As shown, a method 700 begins at step 701, where fabrication system 300 routes fiber strands 301 from fiber spool magazine 310 to fiber impregnator 320 and impregnates fiber strands 301 with fiber impregnator 320. In some embodiments, fiber strands 301 are not wetted or impregnated with a liquid. In such embodiments, step 701 is not performed.

In step 702, each fiber strand 301 is positioned at a respective location within mold cavity 430, as shown in FIG. 8A. FIG. 8A is a cross-sectional side view of a mold cavity 430 during a fiber-positioning step, according to various embodiments. As shown, fiber strands 301 are routed into mold cavity 430 through fiber-positioning plate 420. Thus, fiber strands 301 are positioned at targeted and separate locations within mold cavity 430. In some embodiments, fiber strands 301 extend into a previously cured segment of continuous composite structural member 304 (not shown).

In step 703, fabrication system exerts a tensile force 801 on each of fiber strands 301 disposed within mold cavity 430, as shown in FIG. 8B. FIG. 8B is a cross-sectional side view of polymer mold 330 during a fiber-tensioning step, according to various embodiments. As shown, a tensile force 801 is exerted against fiber strands 301 so that fiber strands 301 are under tension while disposed within mold cavity 430. In some embodiments, tensile force 801 is exerted on fiber strands 301 via a previously cured segment of continuous composite structural member 304 (not shown) that includes fiber strands 301. In such embodiments, tensile force can be generated by tensioning device 350. In the embodiment illustrated in FIG. 8B, tensile force 801 is exerted on fiber strands via a second fiber-positioning plate 802.

In step 704, mold cavity 430 is filled with polymer-containing fluid 303, as shown in FIG. 8C. FIG. 8C is a cross-sectional side view of polymer mold 330 during a polymer filling step, according to various embodiments. In step 704, polymer-containing fluid 303, which can be a molten or softened thermoplastic or polyamide, is injected or flows into casting region 434 of mold cavity 430 via one or more inlets 401. In some embodiments polymer-containing fluid 303 is a liquid, while in other embodiments, polymer-containing fluid 303 is a polymer that has been heated to a temperature equal to or greater than a softening temperature of the polymer. As shown, polymer-containing fluid 303 fills mold cavity 430, envelops fiber strands 301, and flows or is forced toward mold outlet 402. During step 704, tensile force 801 continues to be exerted on fiber strands 301.

In step 705, polymer-containing fluid 303 disposed within mold cavity 430 is cured via cooling, as shown in FIG. 8D. FIG. 8D is a cross-sectional side view of polymer mold 330 during a curing step, according to various embodiments. In step 705, the thermoplastic or polyamide included in polymer-containing fluid 303 cools and solidifies to form a portion of continuous composite structural member 304 with strong surface adhesion between fiber strands 301 and the solidified polymer. In some embodiments, the thermoplastic or polyamide cools while passing through or being extruded through cooling region 435 of mold cavity 430, for example via tensile force 801. Thus, in such embodiments, continuous composite structural member 304 is formed in a continuous process while being extruded from mold cavity 430.

In step 706, composite structural members 309 are produced by cutting continuous composite structural member 304 into segments via cutting device 360. In optional step 707, composite structural members 309 are bent to form non-linear composite structural members 308 at bending station 370. In such embodiments, composite structural members 309 can include polyamide, which can be reheated and softened after curing.

### Injection Process

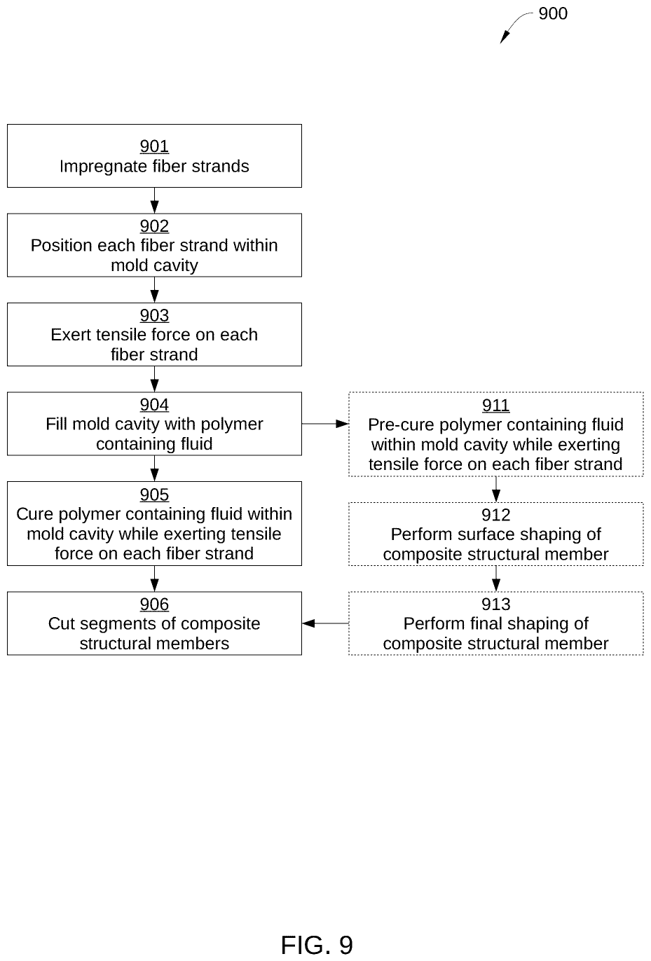

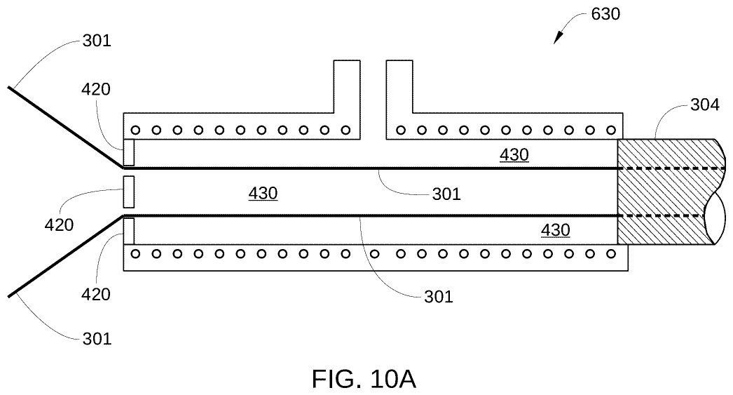

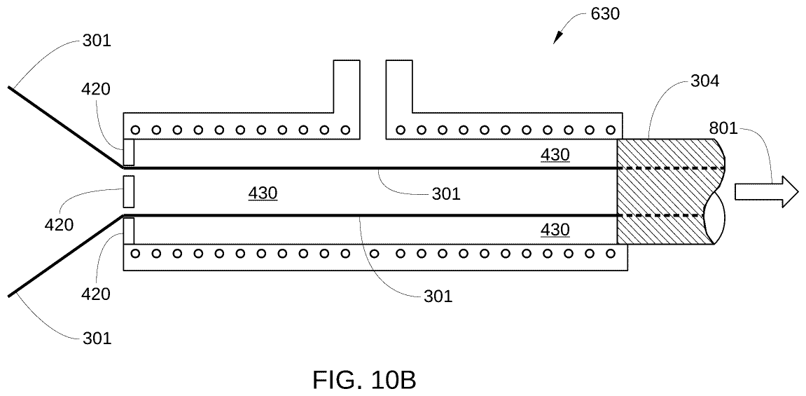

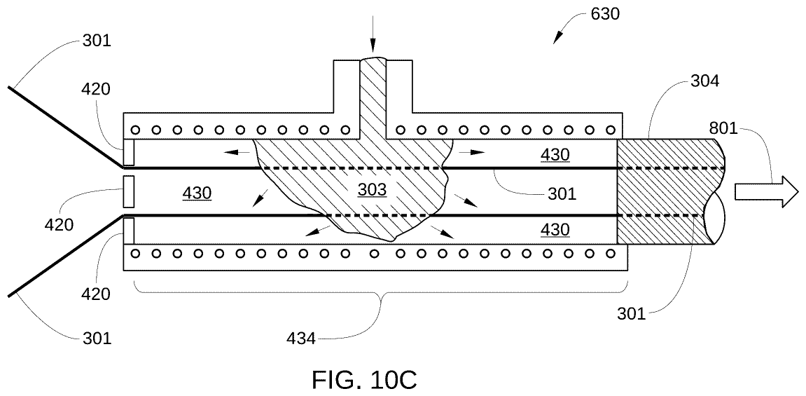

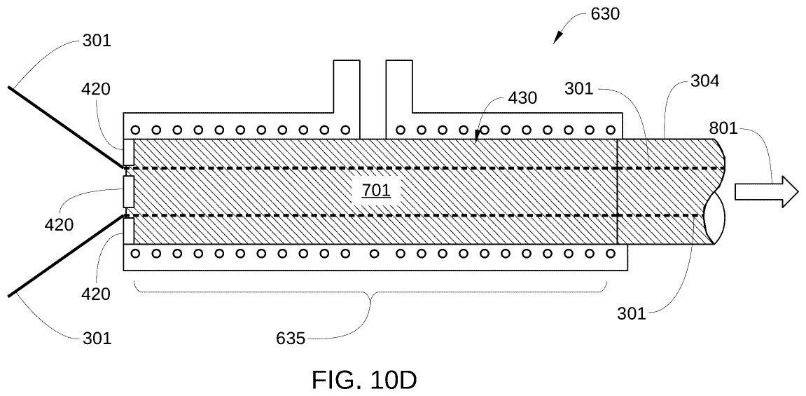

In some embodiments, a novel injection process is employed to fabricate a composite rebar, beam, or other structural member. In the novel injection process, individual fibers (or braided strands) are positioned at specific locations within a mold cavity while under tension. A polymer-containing fluid is then injected into the mold and cured via thermal curing to form a segment of a fiber-reinforced composite member. As the thermo-setting polymer is cured, a tensile force continues to be exerted on the reinforcing fibers within the mold cavity and a discrete segment of a composite structural member is formed in the mold cavity. One embodiment of such an injection process is described below in conjunction with FIGS. 9 and 10A-10D.

FIG. 9 sets forth a flowchart of method steps for fabricating a composite structural member using an extrusion process, according to other various embodiments. FIGS. 10A-10D conceptually illustrate various steps included in method of FIG. 9, the fabrication process, according to various embodiments. Although the method steps are described in conjunction with the systems of FIGS. 1-6, persons skilled in the art will understand that any system configured to perform the method steps, in any order, is within the scope of the embodiments.

As shown, a method 900 begins at step 901, where fabrication system 300 impregnates fiber strands 301 with fiber impregnator 320. In some embodiments, step 901 can be consistent with step 701 of FIG. 7.

In step 902, each fiber strand 301 is positioned at a respective location within mold cavity 430, as shown in FIG. 10A. FIG. 10A is a cross-sectional side view of a polymer mold 330 during a fiber-positioning step, according to other various embodiments. As shown, fiber strands 301 are routed into mold cavity 430 through fiber-positioning plate 420. Thus, fiber strands 301 are positioned at targeted and separate locations within mold cavity 430. In some embodiments, fiber strands 301 extend into a previously cured segment of continuous composite structural member 304.

In step 903, fabrication system exerts a tensile force 801 on each of fiber strands 301 disposed within mold cavity 430, as shown in FIG. 10B. FIG. 10B is a cross-sectional side view of mold cavity 430 during a fiber-tensioning step, according to various embodiments. In some embodiments, step 903 can be consistent with step 703 of FIG. 7.

In step 904, mold cavity 430 is filled with polymer-containing fluid 303, as shown in FIG. 10C. FIG. 10C is a cross-sectional side view of polymer mold 330 during a polymer filling step, according to various embodiments. In step 904, polymer-containing fluid 303, which can be a molten or softened thermos-setting plastic, is injected or flows into casting region 434 of mold cavity 430 via one or more inlets 401. In some embodiments polymer-containing fluid 303 is a liquid, while in other embodiments, polymer-containing fluid 303 is a polymer that has been heated to a temperature equal to or greater than a softening temperature of the polymer. As shown, polymer-containing fluid 303 fills mold cavity 430, envelopes fiber strands 301, and flows or is forced toward mold outlet 402. During step 904, tensile force 801 continues to be exerted on fiber strands 301.

In step 905, polymer-containing fluid 303 disposed within mold cavity 430 is cured via heating, as shown in FIG. 10D. FIG. 10D is a cross-sectional side view of polymer mold 330 during a curing step, according to various embodiments. In step 905, the thermos-setting plastic included in polymer-containing fluid 303 is thermally cured and solidifies to form a portion of continuous composite structural member 304 with strong surface adhesion between fiber strands 301 and the solidified polymer. In some embodiments, the thermo-setting plastic cures in thermal curing region 635. Thus, in such embodiments, a discrete segment of continuous composite structural member 304 is formed in mold cavity 430. In the embodiment illustrated in FIGS. 10A-10D, thermal curing region 635 includes most or all of mold cavity 430. In other embodiments, thermal curing region 635 corresponds to a portion of mold cavity proximate mold outlet 402.

In step 906, composite structural members 309 are produced by cutting continuous composite structural member 304 into segments via cutting device 360.

In alternative embodiments, a pre-curing process is performed on polymer-containing fluid 303 disposed within mold cavity 430. In such embodiments, the precuring activates the polymerization process within an inner portion of the continuous composite structural member 304 being fabricated. The partial curing apparatus enables surface shaping of the composite structural member 304 being fabricated prior to a final curing process. Such embodiments are described below in conjunction with steps 911-913.

In step 911, polymer-containing fluid 303 within thermal curing region 635 of mold cavity 430 is pre-cured while a tensile force is exerted on fiber strands 301. For example, in some embodiments, thermal curing devices 650 initiates the polymerization of polymer-containing fluid 303 via microwaves directed to a center region of mold cavity 330, ultra-violet rays directed to the center region of mold cavity 330, and/or infra-red rays directed to the center region of mold cavity 330.

In step 912, surface shaping is performed on pre-cured continuous composite structural member 304. Because the outer region of pre-cured continuous composite structural member 304 is not fully cured, the outer region of pre-cured continuous composite structural member 304, such as the surface, can be modified. For example, a suitable texture can be applied to the surface of pre-cured continuous composite structural member 304.

In step 913, a final curing process is performed on pre-cured continuous composite structural member 304. For example, a final thermal curing process may be performed on the shaped continuous composite structural member 304. Method 900 then proceeds to step 906, in which composite structural members 309 are produced by cutting continuous composite structural member 304 into segments via cutting device 360.

In sum, the various embodiments described herein provide techniques that enable fabrication of fiber-reinforced composite rebars and beams that have the mechanical properties of conventional composite rebars and beams having orders of magnitude more reinforcing fibers. In some embodiments, the fiber-reinforced composite rebars and beams include pre-tensioned and precisely positioned reinforcing fibers disposed within a cured polymer that enhance the mechanical properties of the rebars and beams.

At least one technical advantage of the disclosed techniques relative to the prior art is that the disclosed techniques enable fabrication of fiber-reinforced composite rebars and beams that have the mechanical properties of conventional composite rebars and beams having orders of magnitude more reinforcing fibers. A further advantage is that the disclosed techniques enable fabrication of fiber-reinforced composite rebars and beams that include pre-tensioned reinforcing fibers that enhance the mechanical properties of the rebar and beams. These technical advantages provide one or more technological advancements over prior art approaches.

1. In some embodiments, an apparatus for fabricating a composite structural member includes: a polymer mold with a mold cavity and an inlet, wherein the inlet is fluidly coupled to the mold cavity and receives a fluid that includes a polymer; a fiber inlet that is disposed on a first end of the mold cavity and includes a fiber-positioning plate; and a tensioner that exerts a tensile force on one or more fiber strands that are routed through the fiber positioning plate.

2. The apparatus of clause 1, wherein the fiber-positioning plate includes a different opening for each fiber strand included in the one or more fiber strands.

3. The apparatus of clauses 1 or 2, wherein each opening corresponds to a location within the mold cavity that resides between an inner surface of the mold cavity and a center axis of the mold cavity.

4. The apparatus of any of clauses 1-3, wherein a first fiber strand that is included in the one or more fiber strands and is routed through the fiber-positioning plate does not contact a second fiber strand that is included in the one or more fiber strands and also is routed through the fiber-positioning plate.

5. The apparatus of any of clauses 1-4, wherein the mold cavity comprises a cooling cavity that forms at least a portion of the composite structural member via an extrusion process.

6. The apparatus of any of clauses 1-5, wherein the mold cavity includes a fiber-infusion region and a curing region.

7. The apparatus of any of clauses 1-6, wherein the mold cavity includes a partial curing zone for initiating polymerization of the fluid in a region of the mold cavity.

8. The apparatus of any of clauses 1-7, wherein the region of the mold cavity corresponds to a core region of the composite structural member.

9. The apparatus of any of clauses 1-8, wherein the partial curing zone initiates the polymerization of the fluid via at least one of microwaves directed towards a center region of the mold cavity, ultra-violet rays directed towards the center region of the mold cavity, or infra-red rays directed towards the center region of the mold cavity.

10. The apparatus of any of clauses 1-9, wherein the mold cavity includes a thermal curing region for causing polymerization of the fluid.

11. The apparatus of any of clauses 1-10, wherein the thermal curing region includes one or more heat-generators.

12. The apparatus of any of clauses 1-11, wherein the mold cavity includes a casting region for receiving the fluid.

13. The apparatus of any of clauses 1-12, wherein the casting region corresponds to a thermal curing region of the mold cavity.

14. The apparatus of any of clauses 1-13, wherein the casting region corresponds to different region of the mold cavity than the thermal curing region of the old cavity.

15. The apparatus of any of clauses 1-14, wherein the tensioner exerts the tensile force on the one or more fiber strands by exerting the tensile force on a cured segment of the composite structural member that is adjacent to the mold cavity.

16. The apparatus of any of clauses 1-15, wherein the tensioner comprises at least one of a pulling roller coupled to each of the one or more fiber strands, a tensioning clamp coupled to each of the one or more fiber strands, a tensioning weight coupled to each of the one or more fiber strands, a servo-driven tensioner coupled to each of the one or more fiber strands, or a hydraulic tensioner coupled to each of the one or more fiber strands.

17. The apparatus of any of clauses 1-16, further comprising a fluid distribution system that provides the fluid to the inlet for the fluid.

18. The apparatus of any of clauses 1-17, further comprising a mixing system that combines a first part of a thermo-setting resin included in the fluid with a second part of the thermo-setting resin included in the fluid before the fluid enters the mold cavity.

19. The apparatus of any of clauses 1-18, further comprising a cutting device for cutting a cured segment of the composite structural member that is outside the polymer mold.

20. The apparatus of any of clauses 1-19, wherein the cutting device comprises at least one of mechanical shear cutters, a laser cutter, a hot knife cutter, a water jet cutter, or a rotary cutting device.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. An apparatus for fabricating a composite structural member, the apparatus comprising:
a polymer mold with a mold cavity and an inlet, wherein the inlet is fluidly coupled to the mold cavity and receives a fluid that includes a polymer;
a fiber inlet that is disposed on a first end of the mold cavity and includes a fiber-positioning plate; and
a tensioner that exerts a tensile force on one or more fiber strands that are routed through the fiber positioning plate.

2. The apparatus of claim 1, wherein the fiber-positioning plate includes a different opening for each fiber strand included in the one or more fiber strands.

3. The apparatus of claim 2, wherein each opening corresponds to a location within the mold cavity that resides between an inner surface of the mold cavity and a center axis of the mold cavity.

4. The apparatus of claim 1, wherein a first fiber strand that is included in the one or more fiber strands and is routed through the fiber-positioning plate does not contact a second fiber strand that is included in the one or more fiber strands and also is routed through the fiber-positioning plate.

5. The apparatus of claim 1, wherein the mold cavity comprises a cooling cavity that forms at least a portion of the composite structural member via an extrusion process.

6. The apparatus of claim 1, wherein the mold cavity includes a fiber-infusion region and a curing region.

7. The apparatus of claim 1, wherein the mold cavity includes a partial curing zone for initiating polymerization of the fluid in a region of the mold cavity.

8. The apparatus of claim 7, wherein the region of the mold cavity corresponds to a core region of the composite structural member.

9. The apparatus of claim 7, wherein the partial curing zone initiates the polymerization of the fluid via at least one of microwaves directed towards a center region of the mold cavity, ultra-violet rays directed towards the center region of the mold cavity, or infra-red rays directed towards the center region of the mold cavity.

10. The apparatus of claim 1, wherein the mold cavity includes a thermal curing region for causing polymerization of the fluid.

11. The apparatus of claim 10, wherein the thermal curing region includes one or more heat-generators.

12. The apparatus of claim 1, wherein the mold cavity includes a casting region for receiving the fluid.

13. The apparatus of claim 12, wherein the casting region corresponds to a thermal curing region of the mold cavity.

14. The apparatus of claim 12, wherein the casting region corresponds to different region of the mold cavity than the thermal curing region of the old cavity.

15. The apparatus of claim 1, wherein the tensioner exerts the tensile force on the one or more fiber strands by exerting the tensile force on a cured segment of the composite structural member that is adjacent to the mold cavity.

16. The apparatus of claim 1, wherein the tensioner comprises at least one of a pulling roller coupled to each of the one or more fiber strands, a tensioning clamp coupled to each of the one or more fiber strands, a tensioning weight coupled to each of the one or more fiber strands, a servo-driven tensioner coupled to each of the one or more fiber strands, or a hydraulic tensioner coupled to each of the one or more fiber strands.

17. The apparatus of claim 1, further comprising a fluid distribution system that provides the fluid to the inlet for the fluid.

18. The apparatus of claim 1, further comprising a mixing system that combines a first part of a thermo-setting resin included in the fluid with a second part of the thermo-setting resin included in the fluid before the fluid enters the mold cavity.

19. The apparatus of claim 1, further comprising a cutting device for cutting a cured segment of the composite structural member that is outside the polymer mold.

20. The apparatus of claim 1, wherein the cutting device comprises at least one of mechanical shear cutters, a laser cutter, a hot knife cutter, a water jet cutter, or a rotary cutting device.
